(19) United States
(12) Patent Application Publication
(10) Pub. No.: US 2005/0247164 A1
(43) Pub. Date: Nov. 10, 2005

(54) Wrench for holding a blot of a bolted connection during tightening or loosening

(76) Inventor: Allister Stewart, SOMERSET (BM)

Correspondence Address: JULIA CHURCH DIERKER;DIERKER & ASSOCIATES, P.C., 3331 W. BIG BEAVER RD. SUITE 109, TROY, MI, 48084-2813, US

(21) Appl. No.: 10/521,895

(22) PCT Filed: Jul. 15, 2003
(86) PCT No.: PCT/GB03/03060

§ 371 Date: Jan. 19, 2005

(51) Int. Cl. B25B 9/00

(52) U.S. Cl. 81/13

(57) ABSTRACT

A tool (10) for use in securing a first element (1) to a second element via at least one threaded bolt (6) passing through an aperture in the first and second elements, the or each bolt having a head (7) locatable substantially adjacent the first element and a nut (19) locatable substantially adjacent the second element. The tool comprises a support structure provided with at least one formation (13) configured to engage the head (7) of the or each respective bolt, the support structure having a releasable engaging arrangement (12,15) configured to engage releasably the first element such that the or each said formation (13) engages the head (7) of the or each respective bolt (6) to prevent rotation of the or each respective bolt (6) within said apertures as the or each nut (19) is readily engaged with a respective bolt.

THE PRESENT INVENTION relates to a tool. More- particularly, the present invention relates to a tool for use in securing a first element to a second element via at least one threaded bolt passing through an aperture in the first and second elements.

It is known to secure a first element to a second element via one or more threaded bolts passing through apertures in the first and second elements; one end of the bolt having an enlarged head to bear immediately against the first element or to bear against a washer interposed between the head of the bolt and the first element wherein, from the other end of the bolt, an internally screw-threaded nut can be threadedly engaged on to the bolt and drawn up tightly to bear against the second element, or against a washer interposed between the nut and the second element. Usually, the nut has a generally hexagonal outer surface, and the head of the bolt can have either a corresponding outer hexagonal surface or can be formed as a screw head having a slot or crossed-slot formation to engage the tip of the screwdriver.

Typically, in order to tighten the nut on the or each bolt, the or each bolt is, in turn, prevented from rotation in its aperture by engagement of either a spanner or socket in the event that the head has an external hexagonal surface, or by the screw-driver, whilst the nut is screwed on to the threaded shank of a bolt by engagement with a spanner or socket. Therefore, it will be seen that it is necessary to use a separate tool on the head of the bolt and the nut of the bolt.

This method of installation is inconvenient where it is not possible for a single person simultaneously to have access to both ends of the bolt at the same time. Such an instant frequently occurs, for example, when fitting out a boat or yacht, where it is necessary to secure a fitting to the top side of a deck, in a position from where it is not convenient or possible for a single person also to have access to the underside of the deck.

It is therefore an object of the present invention to provide an improved tool for use in securing a first element to a second element via at least one threaded bolt passing through an aperture in the first and second element.

According to the present invention, there is provided a tool for use in securing a first element to a second element via at least one threaded bolt passing through an aperture in the first and second elements, the or each bolt having a head locatable substantially adjacent the first element and a nut locatable substantially adjacent the second element; the tool comprising:
a support structure provided with at least one formation configured to engage the head of the or each respective bolt; the support structure having a releasable engaging arrangement configured to engage releasably the first element such that the or each said formation engages the head of the or each respective bolt to prevent rotation of the or each respective bolt within said apertures as the or each nut is threadedly engaged with a respective bolt, wherein the support structure comprises: a plate, and a mechanism, said mechanism being configured to bear against the plate to urge the plate towards the first element when the support structure is engaged with the first element.

Conveniently, the tool has at least two of said formations.

Preferably, the tool has a plurality of said formations provided in a fixed array.

Advantageously, said support structure is configured to slidably engage said plate.

Conveniently, the said support structure is configured to engage the first element slidably.

Preferably, said releasable engaging arrangement comprises an aperture formed through the support structure, the aperture being configured to receive part of the first element therethrough.

Advantageously, said releasable engaging arrangement further comprises a locking pin configured to pass through said part of the first element and to bear against the support structure.

Conveniently, the or each said formation comprises a projection in the form of a screw-driver tip.

Preferably, the or each said formation comprises a projection in the form of a socket configured to receive the head of a respective bolt.

Advantageously, the or each said formation comprises an aperture or recess configured to receive the head of a respective bolt.

So that the invention may be more readily understood, and so that further features thereof may be appreciated, embodiments of the present invention may now be described, by way of example, with reference to the accompanying drawings in which:

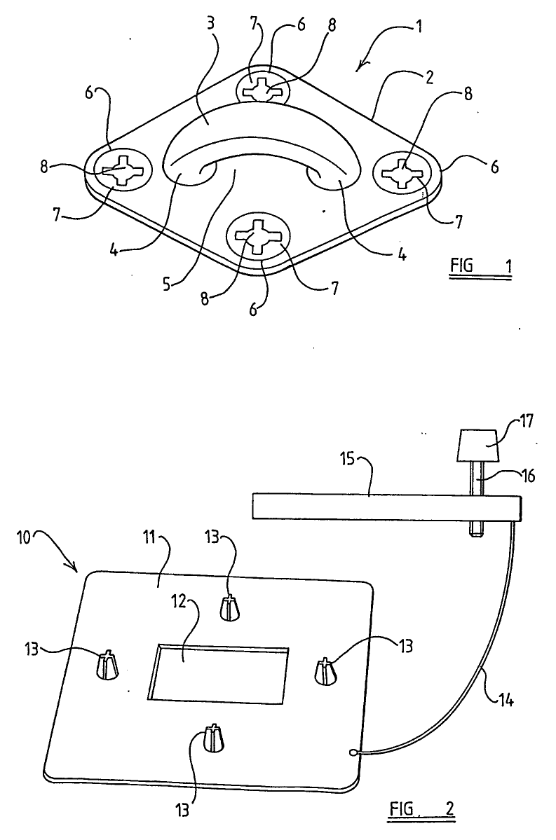

FIG. 1 is a perspective view of a yacht fitting for securement to the deck of a yacht;

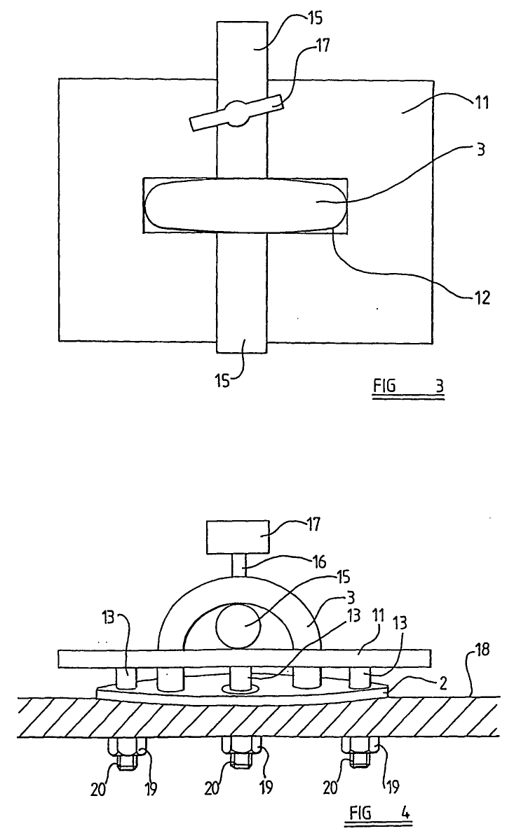

FIG. 2 is a perspective view from below, of a first embodiment of a tool in accordance with the present invention;

FIG. 3 is a plan view from above of the tool illustrated in FIG. 2, in use in securing the yacht fitting illustrated in FIG. 1 to the deck of a yacht;

FIG. 4 is a part-sectional side view of the tool and fitting illustrated in FIG. 3;

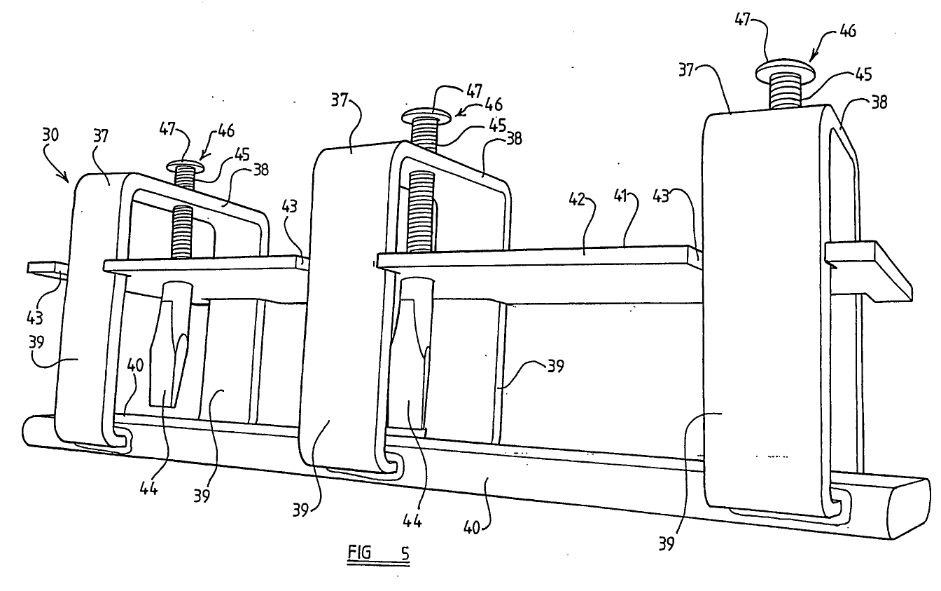

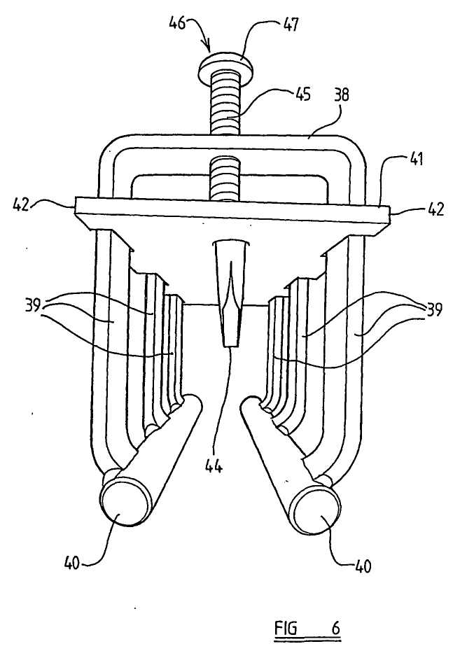

FIG. 5 is a perspective view of a tool in accordance with a second embodiment of the present invention;

FIG. 6 is an end view of the tool illustrated in FIG. 5; and

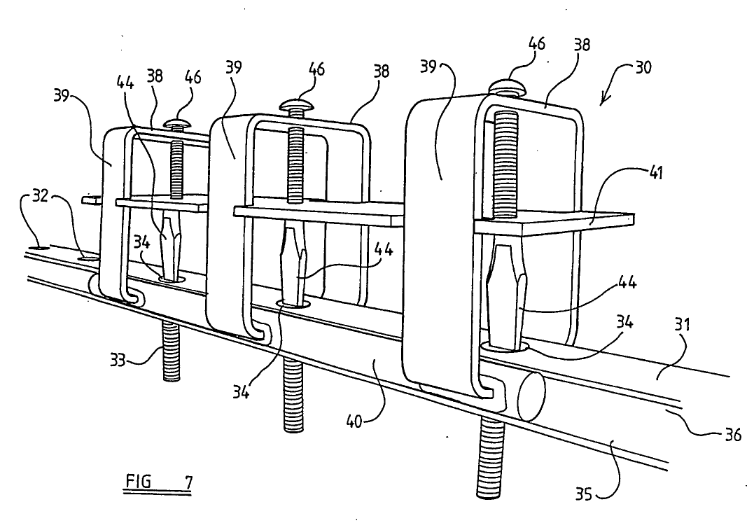

FIG. 7 is a view corresponding generally to that of FIG. 5, illustrating the tool illustrated in FIGS. 5 and 6, engaged with another yacht fitting.

Referring initially to FIG. 1, there is illustrated a known yacht fitting in the form of an eye pad 1. The eye pad 1 illustrated comprises a planar base plate 2 in the form of a parallelogram. Upstanding from one surface of the base plate 2, there is provided a loop 3 which is secured at each end 4 to the base plate 2. The upstanding loop 3 therefore defines a passage 5 therethrough.

The base plate 2 is provided with a plurality of apertures therethrough, each aperture being configured to receive the threaded shank (not illustrated in FIG. 1) of a respective bolt 6. In the particular arrangement illustrated in FIG. 1, the base plate 2 has four apertures and so can receive four bolts, each bolt 6 having a head 7 provided with a conventional screw-driver-receiving crossed- slot recess 8.

The eye pad 1 illustrated in FIG. 1 can be secured to a mounting surface such as the deck of a boat, such that the underside of the base plate 2 bears against the mounting surface, whereafter each bolt 6 is passed through a respective aperture through the base plate 2, and through a respective corresponding aligned aperture through the mounting surface, whereafter an internally-threaded nut of a type known per se can be threadedly engaged with the shank of each bolt and tightened against the deck or against a washer interposed between the deck and the nut.

Turning now to consider FIG. 2, there is illustrated a tool 10 in accordance with a first embodiment of the present invention. The tool 10 comprises a support structure in the form of a generally rectangular support plate 11. In a central region of the support plate 11, there is provided an elongate and generally rectangular slot 12 through the support plate 11. The support plate 11, on one side thereof, carries four formations 13 in the form of screw-driver tip projections. In the particular arrangement as illustrated in FIG. 2, each screw-driver tip projection 13 takes the form of a commonly known cross-head screw-driver tip, but it is equally possible for each projection 13 to take the form of other known types of tool tips such as hexagonal (allen-key) type or simple flat-bladed screw-driver tips.

Each screw-driver tip projection 13 is fixedly mounted to the support plate 11 and therefore cannot rotate with respect to the support plate 11. As will be appreciated from a comparison of FIGS. 1 and 2, the four projections 13 carried by the support plate 11 are provided in a diamond-shaped array corresponding to the diamond-shaped array in which the bolt-receiving apertures are provided in the base plate 2 of the eye pad 1.

Attached to the base plate 11 by a lanyard or tether 14, is a generally elongate, cylindrical locking pin 15. The locking pin 15 is provided with an internally screw-threaded transverse through-bore configured to receive the threaded shank 16 of a thumb screw 17.

Turning now to consider FIGS. 3 and 4, the method of operation of the tool 10 illustrated in FIG. 2 will be described. Firstly, the base plate 2 (which can be considered to represent a first element) is positioned against the mounting surface or deck (which can be considered to represent a second element) in a mounting position such that each bolt-receiving aperture provided through the base plate 2 is aligned with a corresponding bolt-receiving aperture formed through the deck 18. Then, respective bolts 6 are inserted through the aligned eye pad apertures and deck apertures, such that head 7 of each bolt 6 is located substantially adjacent the uppermost surface of the base plate 2. It is to be appreciated, in this regard, that the head 7 of each bolt 6 may either be received in a countersunk aperture, may directly engage the uppermost surface of the base plate 2, or may engage a washer (provided between the uppermost surface of the base plate 2 and the undersurface of the head 7).

Once the eye pad 1 and its associated bolts 6 are mounted in position as described above, the support plate 11 of the tool 10 is positioned over the eye pad 1 such that the upstanding loop 3 of the eye pad 1 is received through the elongate slot 12. It will be appreciated that because the screw-driver tip projections 13 depending from the undersurface of the support plate 11 are provided in fixed array corresponding in shape to the spaced relationship between the apertures through the base plate 2 of the eye pad 1, then each screw-driver tip 13 is configured to engage the recess 8 of a respective bolt head 7, to prevent rotation of the bolts 6 within their apertures.

In order to secure the support plate 11 in its above-mentioned operative position, the locking pin 15 is then passed through the passage 5 defmed through the upstanding loop 3 of the eye pad 1, to bear against the uppermost surface of the support plate 11. The locking pin 15 can be secured in this position by rotation of the thumb screw 17 so that the end of the shank 16 of the thumb screw 17 either simply bears against the uppermost surface of the support plate 11, or is received in an internally threaded aperture or recess provided on the support plate 11.

Once the tool 10 has been installed as described above, the tool serves to prevent rotation of each bolt 6 within its apertures. Thus, it is now possible for the nuts 19 to be threadedly engaged with the shanks 20 which project through the apertures formed in the deck 18. Because the tool 10 is secured in the position illustrated in FIG. 4, and prevents rotation of each bolt 6, a single person can tighten each nut 19 against the undersurface of the deck 18, or a washer interposed between the nut 19 and the deck 18, without simultaneously requiring access to the other side of the deck on which the eye pad 1 is located. After each nut 19 has been tightened in this way, the person can return to the side of the deck 18 on which the eye pad 1 is provided and unscrew the thumb screw 17, to release the locking pin 15 which can then be removed from the loop 3, thereby permitting the support plate 11 to be lifted clear of the eye pad 1, to leave the eye pad 1 securely fastened to the deck 18.

Turning now to consider FIGS. 5 to 7, there is illustrated an alternative tool 30, also embodying the present invention, which is particularly configured for use in securing a length of track 31 (illustrated in FIG. 7) to the deck of a boat. As illustrated in FIG. 7, the track 31 is provided with a plurality of evenly-spaced apertures 32 provided along its length, each aperture 32 extending completely through the track 31 to receive a threaded bolt 33 therethrough, each bolt having a head 34. In the particular arrangement illustrated in FIG. 7, each aperture 32 is countersunk and each head 34 is configured to be received in the countersunk part of each aperture 32 so that when fully engaged therewith, the upper surface of the head 34 is substantially flush with the upper surface of the track 31.

Each longitudinal side face 35 of the track 31 is provided with a longitudinal groove 36 running therealong, each longitudinal groove 36 having a generally concave cross-section.

Turning now to consider FIGS. 5 and 6 in more detail, the tool 30 comprises a support structure in the form of a support frame. The support frame comprises three equi-spaced supports 37, each support 37 being generally U-shaped in configuration. It will therefore be appreciated that each support 37 comprises a transverse web 38 from which a pair of spaced side limbs 39 depend. The supports 37 carry a pair of elongate support bars 40 of substantially cylindrical configuration. The support bars 40 are each secured, at positions therealong, to the free ends of the side limbs 39.

Provided between the transverse webs 38 of each support 37 and the support bars 40, is a generally rectangular support plate 41. Along each longitudinal edge 42 of the support plate 41, there are provided equi-spaced cut-outs 43 configured to slidingly engage a respective side limb 39. It will therefore be appreciated that the support plate 41 is captively and slidingly engaged with the support frame.

Depending from the undersurface of the support plate 41, there are provided three equi-spaced formations taking the form of conventional flat bladed screw-driver tips 44. Each screw-driver tip 44 is fixedly secured to the undersurface of the support plat 41 to prevent any rotation therebetween. However, again the formations could take the form of other types of screw-driver tips.

Each transverse web 38 of the supports 37 is provided with a threaded aperture 45 therethrough which threadingly receives the threaded shank 45 of a respective bolt 46. Each bolt 46 can be provided either with a conventional bolt head 47 as illustrated, or with a thumb screw type head.

FIG. 7 illustrates the tool 30 engaged with the deck track 31 (which can be considered to represent a first element), ready for use in securing the deck track 31 to a deck (which can be considered to represent a second element). The deck track 31 is slidably engaged with the support bars 40 such that each support bar 40 is slidably received within a respective longitudinal groove 36 of the deck track 31. The deck track 31 is aligned with the support structure of the tool 30 such that each screw-driver tip projection 44 is aligned with a respective bolt head 34 carried by the deck track 31.

The deck track 31 can then be placed in a mounting position against the deck to which it is to be mounted, such that each bolt 33 extends through the apertures 32 provided in the deck track 31 and through corresponding, aligned apertures provided through the deck. Thereafter, the support plate 41 can be lowered along the side limbs 39 such that each screw-driver tip projection 44 engages a respective bolt head 34. Then, the clamping bolts 46 threadedly engaged with the transverse webs 38 of each support 37 are driven downwardly such that the lowermost end of each shank 45 bears against the uppermost surface of the support plate 41 to urge the plate 41 towards the deck track 31 in a clamping manner.

When installed in this manner (as illustrated in FIG. 7), the tool 30 serves to prevent rotation of the bolts 33 passing through the deck track 31 and the deck (not shown), whereafter respective nuts can be threadedly engaged with the lowermost end of the bolts 33 in a manner similar to that described in connection with the embodiment illustrated in FIGS. 1 to 4. After each bolt 33 engaged with a respective screw-driver tip projection 44 has had its nut fully tightened, the clamping bolts 46 can be released, thereby allowing the support plate 41 to be lifted which, in turn, permits the screw-driver tip projections 44 to be disengaged with their respective bolt heads 34. The entire tool 30 can then be moved slidably along the deck track 31 for subsequent clamping against the deck track 31 to tighten a further set of bolts 33 extending through the deck track 31. After all of the bolts 33 have been tightened, the tool 30 can be disengaged from the deck track 31 by sliding it off the end of the deck track 31.

It is to be appreciated, however, that the above-mentioned clamping mechanism of the tool 30 illustrated in FIGS. 5 to 7, could, instead of using the clamping bolts 46 threadedly engaged with the transverse webs 37, comprise a rotatable cam shaft mounted for rotation between the transverse webs 38 and the support plate 41, to urge the support plate 41 towards the deck track 31 upon rotation of the cam shaft.

Also, whilst in each of the above-described embodiments of the present invention, the projections for engagement with respect mounting bolts take the form of screw-driver tips, they could, instead, take the form of sockets configured to receive engagingly the heads of the mounting bolts. Alternatively, the projections could be replaced with simple apertures or recesses formed in the support plate 11 of the arrangement illustrated in FIGS. 1 to 4, or the support plate 41 of the arrangement illustrated in FIGS. 1 to 7, each said aperture or recess being configured to receive engagingly the head of a respective mounting bolt.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A tool for use in securing a first element to a second element via at least one threaded bolt passing through an aperture in the first and second elements, the at least one threaded bolt having a head locatable substantially adjacent the first element and a nut locatable substantially adjacent the second element, the tool comprising:
a support structure provided with at least one formation configured to engage the head of the at least one threaded bolt, the support structure having a releasable engaging arrangement configured to releasably engage the first element such that the at least one formation engages the head of the at least one threaded bolt to prevent rotation of the at least one threaded bolt within said apertures as the or each nut is threadedly engaged with a respective bolt, wherein the support structure includes:
a plate; and
a mechanism, said mechanism being configured to bear against the plate to urge the plate towards the first element when the support structure is engaged with the first element.

2. A tool according to claim 1, having at least two of said formations.

3. A tool according to claim 1, having a plurality of said formations provided in a fixed array.

4. A tool according to claim 1, wherein the support structure is configured to slidably engage said plate.

5. A tool according to claim 1, wherein the support structure is configured to slidably engage the first element.

6. A tool according to claim 1, wherein said releasable engaging arrangement comprises an aperture formed through the support structure, the aperture being configured to receive part of the first element therethrough.

7. A tool according to claim 6, wherein said releasable engaging arrangement further comprises a locking pin configured to pass through said part of the first element and to bear against the support structure.

8. A tool according to claim 1, wherein the at least one formation comprises a projection in the form of a screw-driver tip.

9. A tool according to claim 1, wherein the at least one formation comprises a projection in the form of a socket configured to receive the head of a respective bolt.

10. A tool according to claim 1, wherein the at least one formation comprises an aperture or recess configured to receive the head of a respective bolt.

11-13. (canceled)
